(19) United States
(12) Patent Application Publication
(10) Pub. No.: US 2024/0240338 A1
(43) Pub. Date: Jul. 18, 2024

(54) HIGH FLUID VELOCITY CELL DESIGN FOR THE ELECTROCHEMICAL GENERATION OF HYDROGEN AND CARBON DIOXIDE

(71) Applicant: Evoqua Water Technologies LLC, Pittsburgh, PA (US)

(72) Inventors: Joshua Griffis, Ashburnham, MA (US); Simon P Dukes, Chelmsford, MA (US); Li-Shiang Liang, Harvard, MA (US); Benjamin Satterfield, Ayer, MA (US); Zaccur Qasim Fettig, Burlington, MA (US)

(73) Assignee: Evoqua Water Technologies LLC, Pittsburgh, PA (US)

(21) Appl. No.: 18/560,125

(22) PCT Filed: May 11, 2022
(86) PCT No.: PCT/US22/28750

§ 371 Date: Nov. 10, 2023

Related U.S. Application Data
(60) Provisional application No. 63/186,905, filed on May 11, 2021.
(60) Provisional application No. 63/187,519, filed on May 12, 2021.

(51) Int. Cl. C25B 15/031; C25B 1/04; C25B 9/21; C25B 15/033; C25B 15/08

(52) U.S. Cl. CPC C25B 15/031; C25B 1/04; C25B 9/21; C25B 15/033; C25B 15/087

(57) ABSTRACT

Apparatuses for the generation of carbon dioxide and hydrogen from a water having a carbonate species are disclosed. The apparatus includes an anodic compartment having an anode disposed on a first side of the anodic compartment and a cathodic compartment having a cathode disposed on a first side of the cathodic compartment. The apparatus further includes a first cation permeable fluidic separator disposed on a second side of the anodic compartment and a second cation permeable fluidic separator disposed on a second side of the cationic compartment. A center compartment is defined between the first cation permeable fluidic separator and the second cation permeable fluidic separator. The apparatus further includes a flow control system configured to independently control flow of water through each of the anodic compartment, the cathodic compartment, and the center compartment. Methods of generating hydrogen, carbon dioxide, and oxygen from seawater using the apparatus are also disclosed.

### CROSS-REFERENCE TO RELATED APPLICATIONS

This application claims priority under 35 U.S.C. § 119(e) to U.S. Provisional Application Ser. No. 63/186,905, titled “HIGH FLUID VELOCITY CELL DESIGN FOR THE ELECTROCHEMICAL GENERATION OF HYDROGEN AND CARBON DIOXIDE,” filed on May 11, 2021 and U.S. Provisional Application Ser. No. 63/187,519, titled “METHOD OF OPERATING ELECTROCHEMICAL HYDROGEN AND CARBON DIOXIDE GENERATOR,” filed May 12, 2021. Each of these applications is incorporated herein by reference in their entirety for all purposes.

### FIELD OF TECHNOLOGY

Aspects and embodiments disclosed herein relate to devices and methods for acidifying seawater to generate and capture carbon dioxide (CO₂) and hydrogen (H₂).

### SUMMARY

In accordance with an aspect, there is provided an apparatus for the generation of carbon dioxide and hydrogen from a water having a carbonate species. The apparatus may include an anodic compartment having an anode disposed on a first side of the anodic compartment and a cathodic compartment having a cathode disposed on a first side of the cathodic compartment. The apparatus may include a first cation permeable fluidic separator disposed on a second side of the anodic compartment. The apparatus further many include a second cation permeable fluidic separator disposed on a second side of the cathodic compartment. The apparatus further may include a center compartment defined between the first cation permeable fluidic separator and the second cation permeable fluidic separator. The apparatus additionally may include a flow control system configured to independently control flow of water through each of the anodic compartment, the cathodic compartment, and the center compartment.

In further embodiments, the apparatus may include a source of water, e.g., seawater, fluidically connectable to each of the anodic compartment, the cathodic compartment, and the center compartment.

In further embodiments, the apparatus may include a pH sensor disposed downstream of the center compartment and configured to measure the pH of effluent from the center compartment. In certain embodiments, the apparatus may include a controller configured to receive measurements of the pH of the effluent from the center compartment from the pH sensor and to adjust one or both of a flow rate of the water through the center compartment or current applied across the anode and cathode to maintain the pH of the effluent from the center compartment at a predetermined level. The predetermined level is one at which a majority of carbonate species in the effluent from the center compartment exist as carbonic acid, i.e., H₂CO₃.

In some embodiments, the controller may be configured to maintain the pH of the effluent from the center compartment within a range of from about 2.5 to about 6.5.

In further embodiments, the apparatus further may include a conductivity sensor constructed and arranged to measure electrical conductivity of one or more effluents from the anode, cathode, and center compartments. In further embodiments, the controller may be configured to adjust a flow rate of the water through the cathodic compartment responsive to conductivity measurements from the conductivity sensor. In further embodiments, the controller may be configured to adjust a flow rate of effluent from the anodic compartment to the cathodic compartment responsive to conductivity measurements from the conductivity sensor. In further embodiments, the controller may be configured to adjust a flow rate of the water through the cathodic compartment to a flow rate that does not result in formation of scale on the cathode. In further embodiments, the controller may be configured to adjust a flow rate of the water through the anodic compartment responsive to conductivity measurements from the conductivity sensor. In further embodiments, the controller may be configured to minimize a flow rate of the water through the anodic compartment to a flow rate that does not result in blinding of the anode.

In further embodiments, the apparatus may include a recycle line configured to recycle at least a portion of effluent from the anodic compartment to an inlet of the anodic compartment.

In further embodiments, the apparatus may include a recycle line configured to recycle at least a portion of effluent from the cathodic compartment to an inlet of the cathodic compartment. In further embodiments, the apparatus may include a second recycle line configured to recycle at least a portion of effluent from the anodic compartment to the inlet of the cathodic compartment.

In further embodiments, the apparatus may include a recycle line configured to recycle at least a portion of effluent from the center compartment to an inlet of the center compartment. In further embodiments, the apparatus may include a recycle line configured to recycle at least a portion of effluent from the center compartment to an inlet of one or both of the anodic compartment and the cathodic compartment.

In further embodiments, the apparatus may include a gas recovery system configured to remove one or more of hydrogen, carbon dioxide, or oxygen from one or more of the effluent from one or more of the anodic compartment, the cathodic compartment, or the center compartment. In some embodiments, the gas recovery system may include one or more vacuum strippers.

In some embodiments, the anode includes an oxygen evolving coating including one of an iridium oxide or Magneli phase titanium suboxides. In some embodiments, the anode may include alloys including one of stainless steel, iridium-cobalt (Ir—Co), iridium-tantalum (Ir—Ta), or other iridium or tantalum species.

In accordance with an aspect, there is provided a method of generating hydrogen, carbon dioxide, and oxygen from seawater. The method may include introducing the seawater into each of an anodic compartment, a cathodic compartment, and a center compartment of an electrolytic cell. The method may include maintaining one or both of a flow rate through the center compartment or a current across the anode and the cathode at levels that result in effluent from the center compartment exhibiting a pH within a predetermined range. The method may further include maintaining a flow rate through the cathodic compartment at a level that mitigates formation of scale on the cathode. The method further may include maintaining a flow rate through the anodic compartment at a level that mitigates blinding of the anode. The method additionally may include removing one or more of hydrogen, carbon dioxide, or oxygen from effluent from one or more of the anodic compartment, the center compartment, or the cathodic compartment, respectively. The electrolytic cell may include an anode, a cathode, a first cation permeable fluidic separator spaced from the anode and defining the anodic compartment, a second cation permeable fluidic separator spaced from the cathode and defining the cathodic compartment, a center compartment defined between the first cation permeable fluidic separator and the second cation permeable fluidic separator, and a flow control system configured to independently control flow of the seawater through each of the anodic compartment, the cathodic compartment, and the center compartment.

In further embodiments, the method may include maintaining the flow rate through the cathodic compartment at lowest level that mitigates formation of scale on the cathode.

In further embodiments, the method may include maintaining the flow rate through the anodic compartment at a lowest level that mitigates blinding of the anode.

In further embodiments, the method may include introducing a portion of effluent from the anodic compartment into an inlet of the anodic compartment with the seawater introduced into the anodic compartment.

In further embodiments, the method may include introducing a portion of effluent from the anodic compartment into an inlet of the cathodic compartment with the seawater introduced into the anodic compartment.

In further embodiments, the method may include introducing a portion of the effluent from the center compartment into an inlet of the center compartment with the seawater introduced into the center compartment.

In further embodiments, the method may include maintaining the flow rate through at least one of the anodic compartment, the cathodic compartment, or the center compartment at a different level that at least one other of the anodic compartment, the cathodic compartment, or the center compartment.

In further embodiments, the method may include maintaining the flow rate through the cathodic compartment at a higher flow rate than the flow rate through the center compartment.

### BRIEF DESCRIPTION OF THE DRAWINGS

The accompanying drawings are not drawn to scale. In the drawings, each identical or nearly identical component that is illustrated in the various figures is represented by a like numeral. For purposes of clarity, not every component may be labeled in every drawing. In the drawings:

FIG. 1 illustrates an existing electrochemical cell containing ion exchange media for the generation of carbon dioxide and hydrogen from a water having a carbonate species:

FIG. 2 illustrates an apparatus for the generation of carbon dioxide and hydrogen from a water having a carbonate species, according to one embodiment:

FIG. 3 illustrates an apparatus for the generation of carbon dioxide and hydrogen from a water having a carbonate species, according to an alternate embodiment; and

FIGS. 4A-4C illustrate anode and cathode configurations for an apparatus, according to different embodiments. FIG. 4A illustrates a parallel plate arrangement. FIG. 4B illustrates a concentric tube arrangement. FIG. 4C illustrates a spiral wound arrangement.

### DETAILED DESCRIPTION

The total carbon content of the world's oceans is approximately 38,000 gigatons (GT). Over 95% of this carbon is in the form of dissolved bicarbonate ion (HCO₃⁻). This bicarbonate ion, along with the carbonate ion (CO₃²⁻), is responsible for buffering and maintaining the ocean's pH which is relatively constant below the first 100 meters of ocean depth. The dissolved bicarbonate and carbonate ions present in the ocean are effectively bound CO₂, and the sum of the concentrations of these species, along with dissolved gaseous CO₂, represents the total carbon dioxide concentration [CO₂]_{T}, of seawater.

At a typical ocean pH of 7.8, kept relatively constant by a complex bicarbonate-carbonate buffer system, [CO₂]_{T} is about 2000 μmoles/kg near the surface and about 2400 μmoles/kg at depths below 300 meters. This equates to approximately 100 mg/L of [CO₂]_{T}. Of the total CO₂ in the ocean, about 2-3% is dissolved gaseous CO₂, about 1% is present as the dissolve carbonate ion, and the remainder, about 96%, is present as the dissolved bicarbonate ion. It is known that the equilibrium form and concentration of water containing CO₂ and its various ionic forms is dependent on the pH of the water. For example, at a seawater pH of 4.5, 99% of all carbonate species in seawater exist as carbonic acid, H₂CO₃. Thus, in order to convert HCO₃ to H₂CO₃, the pH of seawater may be lowered.

CO₂ dissolved in water is in equilibrium with H₂CO; as shown in equation 1:

$$C {O}_{2} + {H}_{2} O ↔ {H}_{2} C {O}_{3} \qquad ( 1 )$$

The hydration equilibrium constant is 1.70×10 3. This indicates that H₂CO₃ is not stable in water and gaseous CO₂ readily dissociates at pH of 4.5, allowing CO₂ to be easily removed by degassing or stripping once the seawater has been acidified to ensure that the unstable H₂CO₃ is deprotonated to the predominant carbonate species.

Electrochemical cells are used in marine, offshore, municipal, industrial, and commercial implementations. The design parameters of electrochemical cells, for example, inter-electrode spacing, thickness of electrodes and coating density, electrode areas, methods of electrical connections, etc., can be selected for different implementations. Aspects and embodiments disclosed herein are not limited to the number of electrodes, the space between electrodes, the electrode material, material of any spacers between electrodes, number of passes within the electrochemical cells, or electrode coating material.

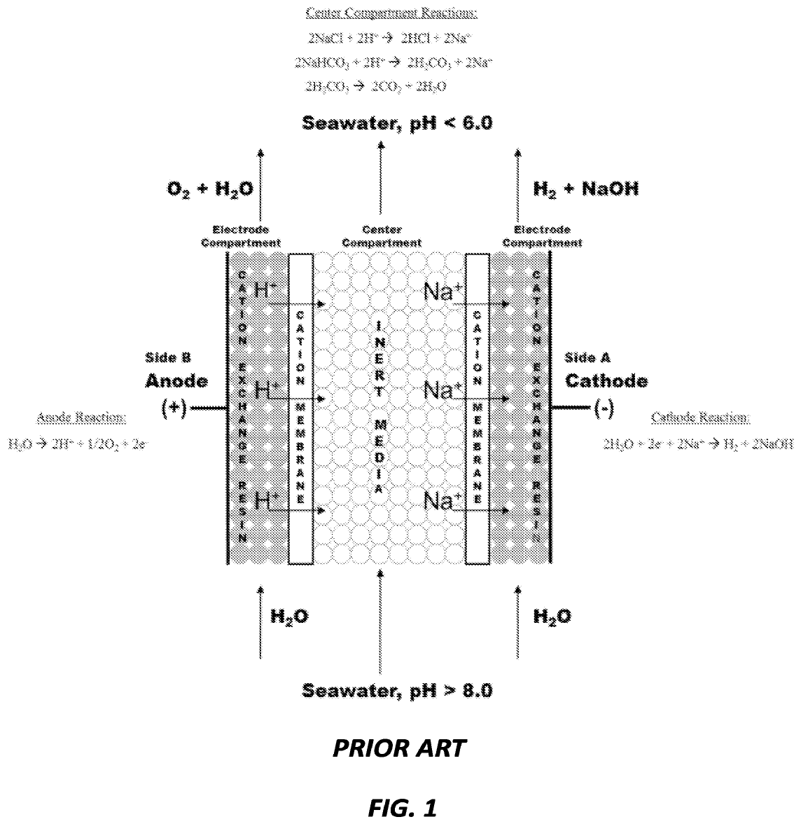

Electrochemical cells including ion exchange media in compartments bounded by membranes have been used to produce carbon dioxide and hydrogen from a water having a carbonate species, such as the existing electrochemical cell illustrated in FIG. 1. In operation, when energized, sodium ions present in the water are exchanged for hydrogen ions as the water flows past two cation exchange membranes that form compartments containing cation exchange resins. The cathode side of the electrochemical cell produces sodium hydroxide and hydrogen gas and the anode side produces oxygen gas. The hydrogen ions entering the center compartment of the electrochemical cell, which includes an inert media, e.g., ceramic particles, to improve the ion transfer efficiency of the cation exchange membranes and cause acidification of the seawater.

This disclosure describes various embodiments of electrochemical cells and electrochemical devices: however, this disclosure is not limited to electrochemical cells or devices and the aspects and embodiments disclosed herein are applicable to electrolytic and electrochemical cells used for any one of multiple purposes.

In certain non-limiting embodiments, this disclosure describes an electrochemical cell for the continuous acidification of water having a carbonate species and recovery of dissolved carbon dioxide with continuous hydrogen gas production. The influent for the electrochemical cell is water having a carbonate species, e.g., a saline water, e.g., seawater, brackish water, or process water, without the need for upstream treatment to reduce the concentration of species such as salts in the water prior to acidification. As used herein, a “saline” water is water containing high concentrations of dissolved solids or salts, for example, a concentration of dissolved salts of between about 500 ppm and about 35,000 ppm. Electrochemical cells as described in this disclosure include an anodic compartment having an anode disposed on a first side of the anodic compartment and a cathodic compartment having a cathode disposed on a first side of the cathodic compartment. The anodic compartment and cathodic compartment are electrolyte- and media-free, permitting higher flow of water having a carbonate species through the compartments. The greater flow velocity of water having a carbonate species through the compartments reduces the potential for scale formation on the compartment's structural elements, such as the anode and cathode. As used herein, flow velocity is a measure of how fast the water directed to the inlets of one or more compartments is moving measured as a distance per unit time. Flow rate is a measure of the volume of water being delivered per unit of time. The flow velocity of the water containing carbonate species generally controls the partitioning of ions across permeable separators, i.e., acidification of the water, and production of O₂, H₂, and CO₂ from the apparatus. In general, other variables that can be measured or quantified, such as flow rate, the aspect ratio of different apparatus components, and friction factors between the water to be treated and the different apparatus components affect the flow velocity of water through the compartments of the apparatus.

The electrochemical cell includes a first cation permeable fluidic separator disposed on a second side of the anodic compartment and a second cation permeable fluidic separator disposed on a second side of the cathodic compartment. A center compartment is defined between the first cation permeable fluidic separator and the second cation permeable fluidic separator. The center compartment may be media-free. The electrochemical cell may be part of an apparatus that includes a flow control system that is constructed and arranged to independently control flow of water having a carbonate species through each of the anodic compartment, the cathodic compartment, and the center compartment.

In operation, a current applied to the apparatus with a water having a carbonate species as influent produces hydrogen gas (H₂) in the cathodic compartment and produces hydrogen ions (H⁺) in the anodic compartment via water splitting without the need for any media, e.g., an ion exchange resin, present in either compartment. The H⁺ ions pass through the first cation permeable fluidic separator and into the center compartment, causing the pH of the water having a carbonate species flowing therein to decrease. The center compartment does not require the use of an inert media, such as ceramic particles, to increase the ion transfer ability or performance of the first cation permeable fluidic separator or the second cation permeable fluidic separator as the flow velocity of water having a carbonate species through the apparatus is sufficient to reduce scaling and performance decreases. This decrease in the pH of the water having a carbonate species results in the conversion of carbonate (CO₃²⁻) and bicarbonate (HCO₃⁻) ions present in the water having a carbonate species to carbon dioxide (CO₂) gas as governed by the equilibrium defined in Eq. 1. No additional current or power or ion exchange media is necessary to decrease the pH of the water having a carbonate species and produce CO₂.

The reactions occurring within the anodic compartment, cathodic compartment, and center compartment, Equations (2)-(4), respectively, include:

$$2 {H}_{2} O \to 4 {H}^{+} + {O}_{2} + 4 {e}^{-} \qquad ( 2 )$$

$$4 {H}_{2} O + 4 {Na}^{+} + 4 {e}^{-} \to 4 NaOH + 2 {H}_{2} \qquad ( 3 )$$

$$4 {NaHCO}_{3} + 4 {H}^{+} \to 4 {Na}^{+} + 4 {H}_{2} {CO}_{3} \qquad ( 4 )$$

The overall reaction for the apparatus (Eq. 5) is thus:

$$2 {H}_{2} O + 4 {NaHCO}_{3} \to 4 {CO}_{2} + 4 NaOH + 8 {H}_{2} + {O}_{2} \qquad ( 5 )$$

where CO₂ is formed in the center compartment subject to the equilibrium of Eq. 1, NaOH and H₂ are formed in the cathodic compartment, and O₂ is formed in the anodic compartment. These reaction products can be captured or otherwise collected and used as feedstock for related processes, such as energy generation, organic synthesis, and oxygenation of water, e.g., aquatic use.

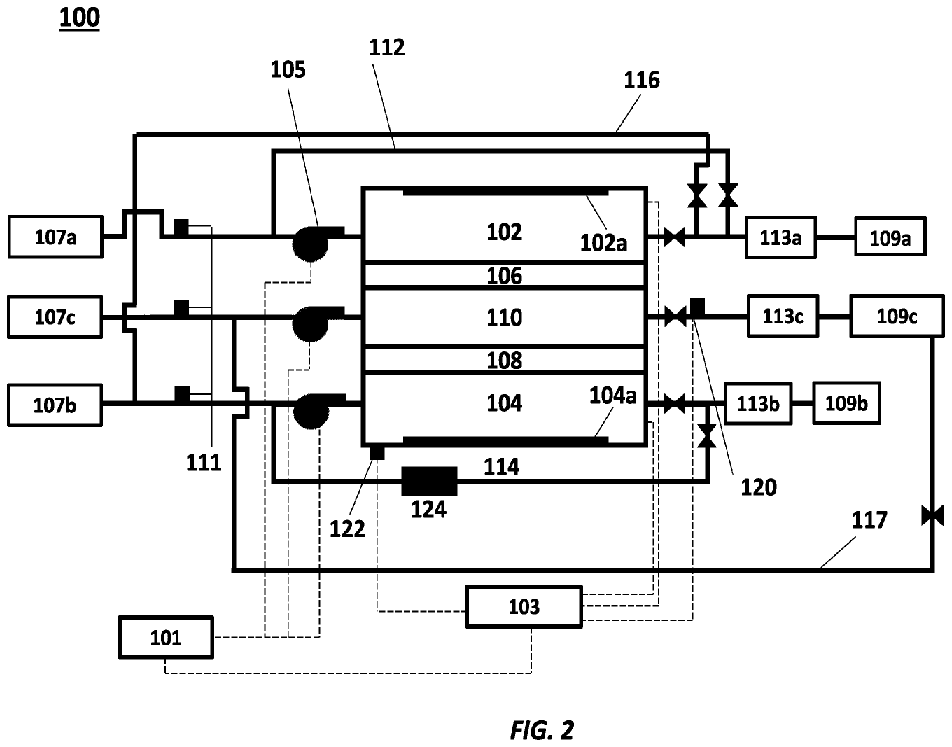

An embodiment of an apparatus for generating carbon dioxide and hydrogen from a water having a carbonate species source is illustrated in FIG. 2. In FIG. 2, apparatus 100 includes an anodic compartment 102 having an anode 102a disposed on a first side of the anodic compartment 102 and a cathodic compartment 104 having a cathode 104a disposed on a first side of the cathodic compartment. A first cation permeable fluidic separator 106 is disposed on a second side of the anodic compartment 102 and a second cation permeable fluidic separator 108 is disposed on a second side of the cathodic compartment 104. The apparatus 100 includes a center compartment 110 defined between the first cation permeable fluidic separator 106 and the second cation permeable fluidic separator 108.

Anodes and cathodes, as used herein, are generally understood to refer to electrodes formed from, comprising, or consisting of one or more metals, for example, titanium, aluminum, nickel, other metals, or alloys thereof. In some embodiments, the anode and/or cathode may include multiple layers of different metals. Metal electrodes utilized in any one or more of the embodiments disclosed herein may include a core of a high conductivity metal, for example, copper or aluminum, coated with a metal or metal oxide having a high resistance to chemical attack by water having a carbonate species, for example, a layer of titanium, platinum, a mixed metal oxide (MMO), Magneli phase titanium, e.g., Ti₄O₇, magnetite, ferrite, cobalt spinel, tantalum, palladium, iridium, silver, gold, or other coating materials. The anode or cathode may be coated with an oxidation resistant coating, for example, but not limited to, platinum, a MMO, magnetite, ferrite, cobalt spinel, tantalum, palladium, iridium, silver, gold, or other coating materials. Mixed metal oxides utilized in embodiments disclosed herein may include an oxide or oxides of one or more of ruthenium, rhodium, tantalum (optionally alloyed with antimony and/or manganese), titanium, iridium, zinc, tin, antimony, a titanium-nickel alloy, a titanium-copper alloy, a titanium-iron alloy, a titanium-cobalt alloy, or other appropriate metals or alloys.

Anodes utilized in embodiments disclosed herein may be coated with platinum and/or an oxide or oxides of one or more of iridium, ruthenium, tin, rhodium, or tantalum (optionally alloyed with antimony and/or manganese). Cathodes utilized in embodiments disclosed herein may be coated with platinum and/or an oxide or oxides of one or more of iridium, e.g., IrO₂, ruthenium, and titanium, e.g., Magneli phase titanium, e.g., Ti₄O₇. Electrodes utilized in any of the electrochemical cell embodiments disclosed herein may include a base of one or more of titanium, tantalum, zirconium, niobium, tungsten, and/or silicon. Electrodes for any of the electrochemical cells within an apparatus disclosed herein can be formed as or from plates, sheets, foils, extrusions, and/or sinters. The anodes and cathodes may be solid electrodes, mesh electrodes, or patterned electrodes.

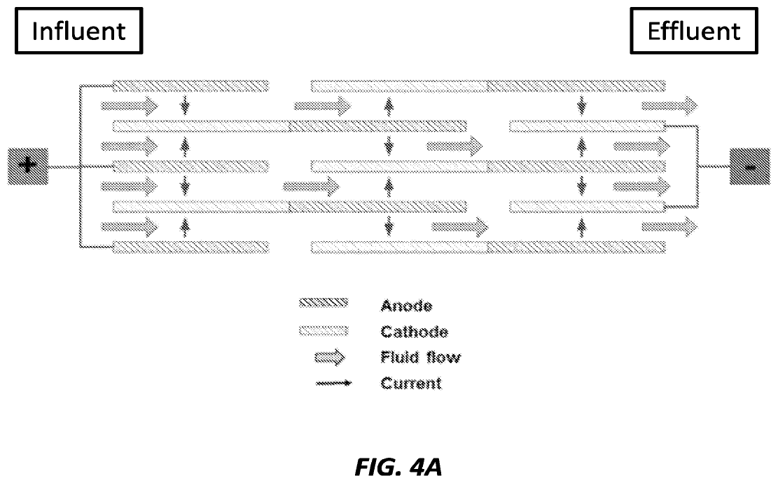

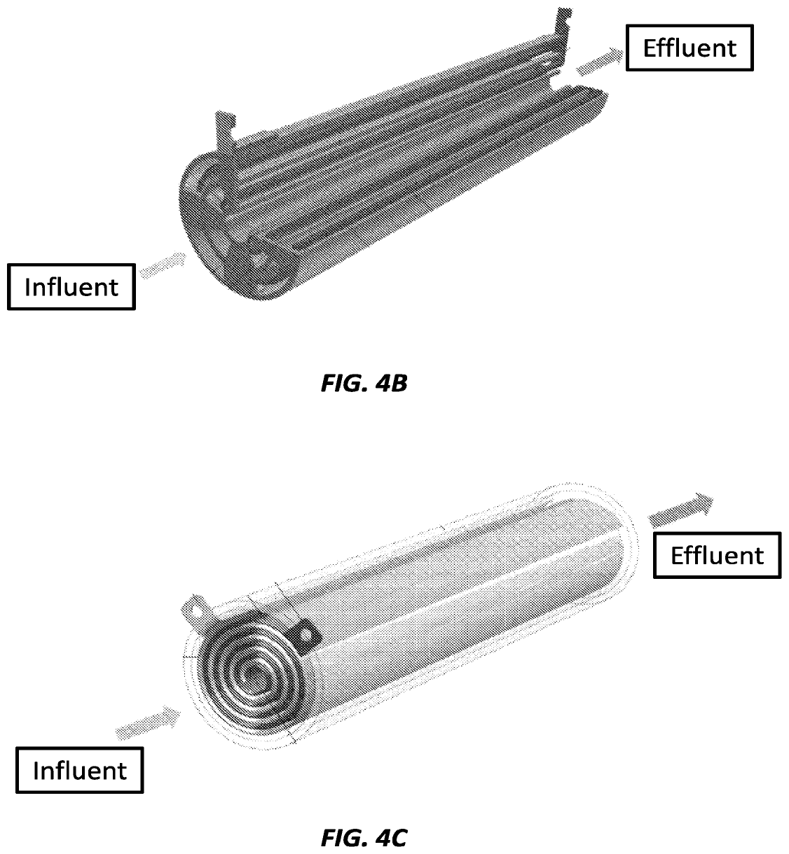

With continued reference to FIG. 2, the anode 102a and cathode 104a can be in any suitable arrangement within the apparatus 100. For example, the anode 102a and cathode 104a may be arranged in a plate and frame configuration, a concentric tube arrangement, or a spiral wound arrangement, illustrated in FIGS. 4A-4C, respectively. The plate and frame configuration in FIG. 4A includes sets of electrodes at each end that are electrically connected in parallel, with one set connected to a positive output from a DC power supply and other set connected to the negative output. The electrodes in between are bipolar. The concentric tube arrangement in FIG. 4B include anodes and cathodes (or anode-cathode pairs) that are constructed and arranged to direct substantially all or all of the water having a carbonate species passing through active areas or gaps between the anodes and cathodes in a direction substantially or completely axially through the active areas. The direction substantially or completely axially through the active areas may be parallel or substantially parallel to the central axis of the electrochemical cell and/or of the anodes and cathodes (or anode-cathode pairs). Water having a carbonate species flowing through and past the active areas of the anode 102a and cathode 104a may still be considered flowing in the direction substantially or completely axially through the active areas even if the flow of the water having a carbonate species exhibits turbulence and/or vortices during flow through the active areas.

The first cation permeable fluidic separator 106 and second cation permeable fluidic separator 108 may be any suitable separation medium that can provide for the desired ion transmission and physical properties for the high flow rates and pressures during use of the apparatus 100. For example, the material used to fabricate one or both of the first cation permeable fluidic separator 106 and second cation permeable fluidic separator 108 may be chosen for high abrasion resistance, flexibility, and selective ion exchange, and the materials used to create the fluid separators may incorporate one or more different materials. High abrasion resistance may be imparted by incorporating ceramic or oxide materials, flexibility may be imparted by incorporating polymeric species, and selective cation exchange may be achieved by specific chemical functionalization. In some embodiments, one or both of the cation permeable fluidic separator 106 and second cation permeable fluidic separator 108 may be cation exchange membrane. Alternatively, one or both of the cation permeable fluidic separator 106 and second cation permeable fluidic separator 108 may be a rigid ceramic separator fabricated using processes such as low temperature hydrothermal liquid phase densification. Fluid separators fabricated using these processes can be formed into geometric shapes that provide for varying ratios of functional surface area to volume to improve apparatus efficiency for acidification of water having a carbonate species and product gas generation.

The apparatus 100 further includes a flow control system 101 constructed and arranged to independently control flow of water having a carbonate species through each of the anodic compartment 102, the cathodic compartment 104, and the center compartment 110. The flow control system 101 may be operatively coupled to elements used to control the flow of fluids, such as pumps 105 or valves positioned throughout the apparatus 100. The apparatus 100 includes flow meters or flow sensors 111 positioned one or both of upstream or downstream of the anodic compartment 102, the cathodic compartment 104, and the center compartment 110 that are operatively coupled to the flow control system. As illustrated, flow meters or flow sensors 111 are positioned upstream of the anodic compartment 102, the cathodic compartment 104, and the center compartment 110 but this disclosure contemplates substantially equivalent flow meters or flow sensors positioned downstream of the anodic compartment 102, the cathodic compartment 104, and the center compartment 110.

With continued reference to FIG. 2, the apparatus 100 is connectable to a source of water having a carbonate species, e.g., saline water, e.g., seawater, brackish water, a treated water retentate, or a process water, as influent to each of the anodic compartment 102, the cathodic compartment 104, and the center compartment 110. The source of water having a carbonate species may be independent sources of water 107a, 107b, or 107c that are connectable to the anodic compartment 102, the cathodic compartment 104, and the center compartment 110, respectively. Alternatively, the anodic compartment 102, the cathodic compartment 104, and the center compartment 110 may each be connectable to a single source of the water having a carbonate species, in which instance sources 107a, 107b, and 107c may each be the same source of water having a carbonate species.

The apparatus 100 include one or more sensors positioned upstream or downstream of the anodic, cathodic, and center compartments constructed and arranged to measure one or more parameters of the water having a carbonate species influent 107a, 107b, or 107c and/or effluents 109a, 109b, and 109c. The one or more sensors may include, for example, flow meters, water level sensors, conductivity meters, resistivity meters, chemical concentration meters, turbidity monitors, chemical species specific concentration sensors, temperature sensors, pH sensors, oxidation-reduction potential (ORP) sensors, pressure sensors, or any other sensor, probe, or scientific instrument useful for providing an indication of a desired characteristic or parameter of the water having a carbonate species entering or effluent exiting any one or more of the anodic, cathodic, and center compartments. As illustrated in FIG. 2, the apparatus 100 includes a pH sensor 120 disposed downstream of the center compartment 110 and configured to measure the pH of effluent 109c from the center compartment 110. The pH sensor 120 is any type of suitable pH sensor. The apparatus 100 further includes conductivity sensor 122 constructed and arranged to measure the electrical conductivity between the anode 102a and cathode 104a.

With continued reference to FIG. 2, apparatus 100 includes a controller 103 generally constructed and arranged to control operation of the apparatus 100. In some embodiments, the controller 103 is configured to receive measurements of the pH of the effluent 109c from the center compartment 110 from the pH sensor 120. The controller 103 is configured to adjust one or both of a flow rate, e.g., by communicating with the flow control system 101, of the water having a carbonate species from the source of water having a carbonate species 107c for the center compartment through the center compartment 110 or the current applied across the anode 102a and cathode 104a to maintain the pH of the effluent 109c from the center compartment 110 at a predetermined level. This predetermined pH level is typically between about 2.5 to about 6.5, e.g., about 2.5, about 3, about 3.5, about 4, about 4.5, about 5, about 5.5, about 6, or about 6.5. The water having a carbonate species effluent 109a, 109b, and 109c includes carbonate species and the predetermined level is one at which a majority of carbonate species in the effluent 109c from the center compartment 110 exists as carbonic acid H&CO; which is in equilibrium with CO₂ and H₂O as shown in Eq. 1. Without wishing to be bound by any particular theory, the production of hydrogen ions in the anodic compartment and the consumption of hydrogen ions in the center compartment is correlated to the flow of water through the respective compartments. Thus, control of the flow of water through these compartments can control the pH of the effluent 109c of the center compartment

In some embodiments, the output from the conductivity sensor 122 is transmitted to the controller 103 and is used by the controller 103 to determine whether to adjust one or more water having a carbonate species flow rates through the apparatus 100. Adjustments of the flow rate of water having a carbonate species into or out of the apparatus 100 can adjust the production, i.e., the pH, of acidified water having a carbonate species through the center compartment 110, improve apparatus 100 efficiency, reduce apparatus 100 energy consumption, and reduce maintenance downtime. In some embodiments, the controller 103 is configured to adjust a flow rate of the water having a carbonate species from cathodic influent 107b through the cathodic compartment 104 responsive to the conductivity measurements from the conductivity sensor 122.

In some embodiments, the controller 103 may receive conductivity measurements from one or more conductivity sensors positioned to measure the conductivity of the effluent of one or more of the effluents 109a, 109b, and 109c from the anodic compartment, cathodic compartment, and center compartment, respectively. The conductivity measurements from the effluents 109a, 109b, and 109c from the anodic compartment, cathodic compartment, and center compartment, respectively can be used to by the controller 103 to determine how to adjust the flow of water through each compartment individually or through combinations of the individual compartments to control the acidification of water in the center compartment and the production of CO₂.

The measurement from the conductivity sensor 122 will be indicative of the formation of ion scale on the cathode 104a and increasing the flow rate through the cathodic compartment 104 will reduce the potential for further scaling on the cathode 104a. In some embodiments, the controller 103 is configured to adjust a flow rate of effluent 109a from the anodic compartment 102 to the cathodic compartment 104 responsive to conductivity measurements from the conductivity sensor 120. The measurement from the conductivity sensor 122 will be indicative of the formation of ion scale on the cathode 104a and increasing the flow rate of effluent 109a from the anodic compartment 102 to the cathodic compartment 104 will reduce the potential for further scaling on the cathode 104a. In addition, and as shown in Eqs. 2-4, the chemical reactions in the cathodic compartment 104 produce NaOH, which is caustic and can cause degradation of the second cation permeable fluidic separator 108 or degradation of the cathode 104a. The recycled water from recycle line 118 into the cathodic compartment 104 reduces the NaOH concentration therein, reducing scale on the cathode 104a and increasing apparatus 100 longevity. In some embodiments, the controller 103 is configured to minimize a flow rate of the water having a carbonate species from cathodic influent 107b through the cathodic compartment 104 to a flow rate that does not result in formation of scale on the cathode. As used in the context of this disclosure, scale on the cathode can generally include any coating on the electrode formed from precipitated species, such as precipitated carbonates and oxides formed as the pH of the water changes during treatment. The formation of scale on the cathode can reduce the surface area of the active area of the cathode, reducing the efficiency of the cathode for the formation of H₂ gas via water reduction. The flow rate and/or flow velocity of water through the cathodic compartment can be adjusted, i.e., lowered, to a rate that balances the formation of H₂ gas, and subsequently CO₂ gas in the center compartment while maintaining sufficient flow through the apparatus to reduce precipitation of scale that may adsorb onto the cathode.

In some embodiments, the controller 103 is configured to adjust a flow rate of the water having a carbonate species from the anodic influent 107a through the anodic compartment 102 responsive to conductivity measurements from the conductivity sensor 120. In some embodiments, the controller 103 is configured to minimize a flow rate of the water having a carbonate species from the anodic influent 107a through the anodic compartment 102 to a flow rate that does not result in blinding of the anode 102a by gas, e.g., O₂ generated at the anode 102a. As used herein, blinding on an electrode generally refers to the active area of an electrode, e.g., the anode, having portions of its active area having bubbles of gas adhered to the active area, reducing efficiency for further gas production when energized. Anode blinding can be evaluated, in general, by measuring the volume of gas produced from an electrochemical process and comparing the measured volume to what is theoretically expected based on the relevant half reactions or by measuring conductance across the anode/cathode pair. The flow rate and/or flow velocity of water through the anodic compartment can be adjusted, i.e., lowered, to a rate that balances the formation of O₂ gas, and subsequently CO₂ gas in the center compartment while maintaining sufficient flow through the apparatus to reduce the formation of bubbles that may adsorb onto the anode.

Without wishing to be bound by any particular theory, an increase in flow rate will generally reduce the residence time of the water having a carbonate species in the cathodic compartment and thus reduce the amount of time ions in the water having a carbonate species are contacting the electrified surface of the cathode. This further applies to the anode, as the decrease in residence time through the anodic compartment will reduce the formation of O₂ on the anode. For example, the flow rate of water having a carbonate species through the apparatus may be from about 0.1 m/s to about 10 m/s, e.g., about 0.1 m/s to about 10 m/s, about 0.5 m/s to about 9 m/s, about 1 m/s to about 8 m/s, about 2 m/s to about 7 m/s, about 3 m/s to about 6 m/s, or about 4 m/s to about 5 m/s, e.g., about 0.1 m/s, about 0.5 m/s, about 1 m/s, about 1.5 m/s, about 2 m/s, about 2.5 m/s, about 3 m/s, about 3.5 m/s, about 4 m/s, about 4.5 m/s, about 5 m/s, about 5.5 m/s, about 6 m/s, about 6.5 m/s, about 7 m/s, about 7.5 m/s, about 8 m/s, about 8.5 m/s, about 9 m/s, about 9.5 m/s, or about 10 m/s. In certain embodiments, the flow rate of water having a carbonate species through the apparatus may be about 2 m/s to 3 m/s.

The controller 103 may be implemented using one or more computer systems. The computer system may be, for example, a general-purpose computer such as those based on an Intel CORER-type processor, an Intel XEON®-type processor, an Intel CELERON®-type processor, an AMD FX-type processor, an AMD RYZEN®-type processor, an AMD EPYC R-type processor, and AMD R-series or G-series processor, or any other type of processor or combinations thereof. Alternatively, the computer system may include programmable logic controllers (PLCs), specially programmed, special-purpose hardware, for example, an application-specific integrated circuit (ASIC) or controllers intended for analytical systems. In some embodiments, the controller 103 may be operably connected to or connectable to a user interface constructed and arranged to permit a user or operator to view relevant operational parameters of the apparatus 100, adjust said operational parameters, and/or stop operation of the apparatus 100 as needed. The user interface may include a graphical user interface (GUI) that includes a display configured to be interacted with by a user or service provider and output status information of the apparatus 100.

The controller 103 can include one or more processors typically connected to one or more memory devices, which can comprise, for example, any one or more of a disk drive memory, a flash memory device, a RAM memory device, or other device for storing data. The one or more memory devices can be used for storing programs and data during operation of the apparatus 100. For example, the memory device may be used for storing historical data relating to the parameters over a period of time. Software, including programming code that implements embodiments of the invention, can be stored on a computer readable and/or writeable nonvolatile recording medium, and then typically copied into the one or more memory devices wherein it can then be executed by the one or more processors. Such programming code may be written in any of a plurality of programming languages, for example, ladder logic, Python, Java, Swift, Rust, C, C #, or C++, G, Eiffel, VBA, or any of a variety of combinations thereof.

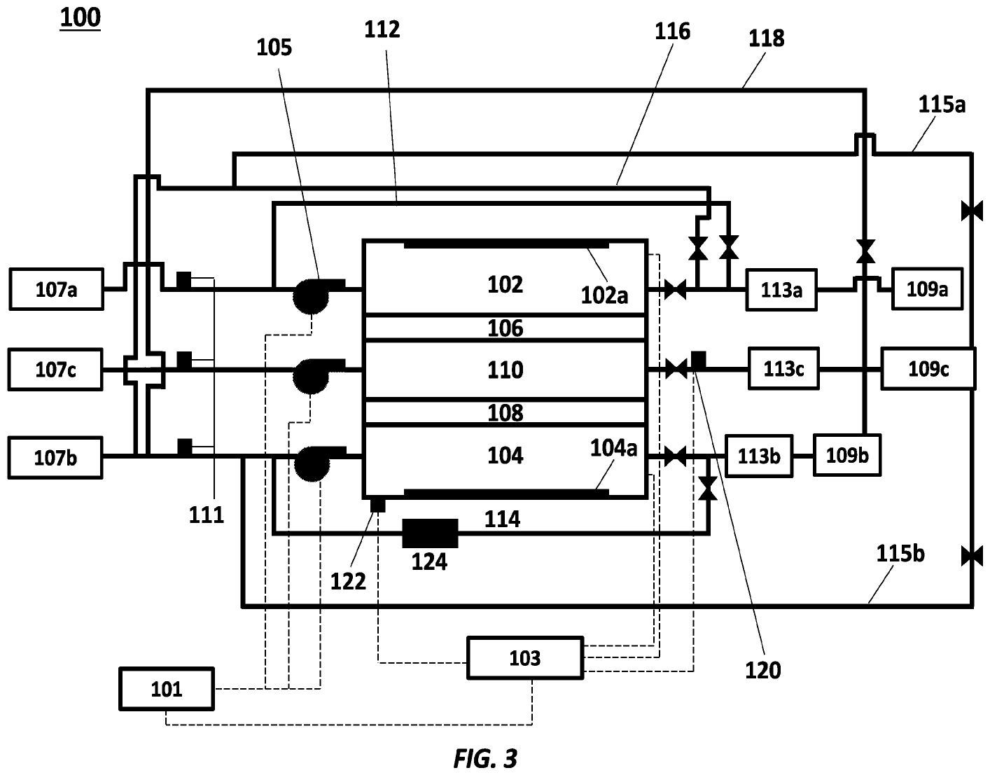

With continued reference to FIG. 2, the apparatus 100 includes one or more recycle lines constructed and arranged to divert a portion of the effluent from one or more of the anodic effluent 109a, cathodic effluent 109b, and center effluent 109c back to one or more inlets of the anodic compartment 102, cathodic compartment 104, and/or center compartment 110. In some embodiments, the apparatus 100 includes a recycle line 112 configured to recycle at least a portion of effluent 109a from the anodic compartment 102 to an inlet of the anodic compartment 102. In alternate embodiments, such as shown in FIG. 3, a portion of the effluent 109c from the center compartment 110 may be directed to an inlet of one of both of the anodic compartment 102 via conduit 115a and the cathodic compartment 104 via conduit 115b. The effluent 109c from the center compartment 110 can be used to lower the pH of the influent into the anodic compartment 102, thus improving the efficiency of oxygen evolution within the anodic compartment 102, e.g., improved H⁺ utilization. The effluent 109c from the center compartment 110 can be used to lower the total carbonate species concentration in the cathodic compartment 104, thus decreasing scale formation on the cathode 104a.

In some embodiments, the apparatus 100 includes a recycle line 114 configured to recycle at least a portion of effluent 109b from the cathodic compartment 104 to an inlet of the cathodic compartment 104. The recycle line 114 from the effluent 109b from the cathodic compartment 104 to an inlet of the cathodic compartment 104 further may include an inline treatment system 124 to reduce the concentration of divalent species present in the cathodic compartment effluent 109b. For example, the inline treatment system 124 may include, but is not limited to, one or more of nanofiltration, reverse osmosis, ion exchange treatments, nanobead treatment, electrodeionization, and capacitive deionization. The inline treatment system may be used to reduce the potential for scaling of the cathode 104a if it is determined that high water velocity through the cathodic compartment 104 cannot sufficiently reduce scaling potential. In some embodiments, the apparatus 100 includes a second recycle line 116 configured to recycle at least a portion of effluent 109a from the anodic compartment to the inlet of the cathodic compartment 104. In some embodiments, the apparatus 100 includes a recycle line 117 configured to recycle at least a portion of effluent from the center compartment 109c to an inlet of the center compartment 110.

In some embodiments, apparatus 100 includes a gas recovery system 113a, 113b, 113c constructed and arranged to remove one or more dissolved gases from the effluent from one or more of the anodic compartment 102, the cathodic compartment 104, or the center compartment 110. As illustrated in FIG. 2, effluent 109a, 109b, and 109c from the anodic compartment 102, the cathodic compartment 104, or the center compartment 110 has a gas recovery system 113a, 113b, and 113c. Alternatively, the apparatus 100 may include one gas recovery system connectable to each of the outlets for effluents 109a, 109b, and 109c from the anodic compartment 102, the cathodic compartment 104, or the center compartment 110, respectively. The gas recovery system 113a, 113b, 113c may be any suitable system that can remove dissolved gases from water, including but not limited to, forced draft degasifier, break tank, vacuum stripper, air stripper, or a membrane degasifier. In certain embodiments, the gas recovery system includes one or more vacuum strippers. The gas recovery system is constructed and arranged to remove one or more of H₂, CO₂, and O₂ from one or more of the effluents 109a, 109b, 109c from the anodic compartment 102, the cathodic compartment 104, and/or the center compartment 110. The gas recovery system may be configured to remove at least 80% of the H₂, CO₂, and/or O₂ from one or more of the effluents 109a, 109b, 109c from one or more of the anodic compartment 102, the cathodic compartment 104, or the center compartment 110. In particular embodiments, the gas recovery system may be configured to remove at least 90%, at least 95%, at least 99%, at least 99.9%, at least 99.99%, 99.999%, or 100% of the of H₂, CO₂, and O₂ from one or more of the effluents 109a, 109b, 109c from one or more of the anodic compartment 102, the cathodic compartment 104, or the center compartment 110.

In accordance with an aspect, there is provided a method of generating hydrogen, carbon dioxide, and oxygen from seawater. The method may include introducing the seawater into each of an anodic compartment, a cathodic compartment, and a center compartment of an electrolytic cell. The method may include maintaining one or both of a flow rate through the center compartment or a current across the anode and the cathode at levels that result in effluent from the center compartment exhibiting a pH within a predetermined range. The method may further include maintaining a flow rate through the cathodic compartment at level that mitigates formation of scale on the cathode. The method further may include maintaining a flow rate through the anodic compartment at a level that mitigates blinding of the anode. The method additionally may include removing one or more of hydrogen, carbon dioxide, or oxygen from effluent from one or more of the anodic compartment, the center compartment, or the cathodic compartment, respectively. The electrolytic cell may include an anode, a cathode, a first cation permeable fluidic separator spaced from the anode and defining the anodic compartment, a second cation permeable fluidic separator spaced from the cathode and defining the cathodic compartment, a center compartment defined between the first cation permeable fluidic separator and the second cation permeable fluidic separator, and a flow control system configured to independently control flow of the seawater through each of the anodic compartment, the cathodic compartment, and the center compartment.

In some embodiments, the method further may include maintaining the flow rate through the cathodic compartment at lowest level that mitigates formation of scale on the cathode. In some embodiments, the method further may include maintaining the flow rate through the anodic compartment at a lowest level that mitigates gas blinding of the anode.

The method of generating hydrogen, carbon dioxide, and oxygen from seawater further may include introducing a portion of effluent from the anodic compartment into an inlet of the anodic compartment with the seawater introduced into the anodic compartment to reduce the production of gas and blinding of the anode by the evolved gas. In some embodiments, the method may include introducing a portion of effluent from the anodic compartment into an inlet of the cathodic compartment with the seawater introduced into the anodic compartment to reduce the concentration of caustic species produced in the cathodic compartment. In some embodiments, the method further may include introducing a portion of effluent from the cathodic compartment into an inlet of the cathodic compartment with the seawater introduced into the cathodic compartment to reduce the formation of scale on the cathode. In some embodiments, the method additionally may include introducing a portion of the effluent from the center compartment into an inlet of the center compartment with the seawater introduced into the center compartment to shift the equilibrium towards the evolution of CO₂ gas.

The method of generating hydrogen, carbon dioxide, and oxygen from seawater may include maintaining the flow rate through at least one of the anodic compartment, the cathodic compartment, or the center compartment at a different level that at least one other of the anodic compartment, the cathodic compartment, or the center compartment. In some embodiments, the method further may include maintaining the flow rate through the cathodic compartment at a higher flow rate than the flow rate through the center compartment to reduce scale on the cathode and to decrease the concentration of caustic species, e.g., NaOH, formed in the cathodic compartment.

The phraseology and terminology used herein is for the purpose of description and should not be regarded as limiting. As used herein, the term “plurality” refers to two or more items or components. The terms “comprising,” “including,” “carrying.” “having,” “containing.” and “involving.” whether in the written description or the claims and the like, are open-ended terms, i.e., to mean “including but not limited to.” Thus, the use of such terms is meant to encompass the items listed thereafter, and equivalents thereof, as well as additional items. Only the transitional phrases “consisting of” and “consisting essentially of,” are closed or semi-closed transitional phrases, respectively, with respect to the claims. Use of ordinal terms such as “first,” “second,” “third,” and the like in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment, it is to be appreciated various alterations, modifications, and improvements will readily occur to those skilled in the art. Any feature described in any embodiment may be included in or substituted for any feature of any other embodiment. Such alterations, modifications, and improvements are intended to be part of this disclosure and are intended to be within the scope of the invention. Accordingly, the foregoing description and drawings are by way of example only.

Those skilled in the art should appreciate that the parameters and configurations described herein are exemplary and that actual parameters and/or configurations will depend on the specific application in which the disclosed methods and materials are used. Those skilled in the art should also recognize or be able to ascertain, using no more than routine experimentation, equivalents to the specific embodiments disclosed.

What is claimed is:

1. An apparatus for generation of carbon dioxide and hydrogen from a water having carbonate species, the apparatus comprising:
an anodic compartment;
an anode disposed on a first side of the anodic compartment;
a cathodic compartment;
a cathode disposed on a first side of the cathodic compartment;
a first cation permeable fluidic separator disposed on a second side of the anodic compartment;
a second cation permeable fluidic separator disposed on a second side of the cationic compartment;
a center compartment defined between the first cation permeable fluidic separator and the second cation permeable fluidic separator; and
a flow control system configured to independently control flow of the water through each of the anodic compartment, the cathodic compartment, and the center compartment.

2. The apparatus of claim 1, further comprising a source of water fluidically connectable to each of the anodic compartment, the cathodic compartment, and the center compartment.

3. The apparatus of claim 1, further comprising a pH sensor disposed downstream of the center compartment and configured to measure the pH of effluent from the center compartment.

4. The apparatus of claim 3, further comprising a controller configured to receive measurements of the pH of the effluent from the center compartment from the pH sensor and to adjust one or both of a flow rate of the water through the center compartment or current applied across the anode and cathode to maintain the pH of the effluent from the center compartment at a predetermined level.

5. The apparatus of claim 4, wherein the predetermined level is one at which a majority of carbonate species in the effluent from the center compartment exist as H₂CO₃.

6. The apparatus of claim 5, wherein the controller is configured to maintain the pH of the effluent from the center compartment within a range of from about 2.5 to about 6.5.

7. The apparatus of claim 1, further comprising a conductivity sensor configured to measure electrical conductivity of one or more effluents from the anode, cathode, and center compartments.

8. The apparatus of claim 7, wherein the controller is further configured to adjust a flow rate of the water through the cathodic compartment responsive to conductivity measurements from the conductivity sensor.

9. The apparatus of claim 8, wherein the controller is further configured to adjust a flow rate of effluent from the anodic compartment to the cathodic compartment responsive to conductivity measurements from the conductivity sensor.

10. The apparatus of claim 7, wherein the controller is further configured to adjust a flow rate of the water through the cathodic compartment to a flow rate that does not result in formation of scale on the cathode.

11. The apparatus of claim 7, wherein the controller is further configured to adjust a flow rate of the water through the anodic compartment responsive to conductivity measurements from the conductivity sensor.

12. The apparatus of claim 7, wherein the controller is further configured to minimize a flow rate of the water through the anodic compartment to a flow rate that does not result in blinding of the anode.

13. The apparatus of claim 1, further comprising a recycle line configured to recycle at least a portion of effluent from the anodic compartment to an inlet of the anodic compartment.

14. The apparatus of claim 1, further comprising a recycle line configured to recycle at least a portion of effluent from the cathodic compartment to an inlet of the cathodic compartment.

15. The apparatus of claim 14, further comprising a second recycle line configured to recycle at least a portion of effluent from the anodic compartment to the inlet of the cathodic compartment.

16. The apparatus of claim 1, further comprising a recycle line configured to recycle at least a portion of effluent from the center compartment to an inlet of the center compartment.

17. The apparatus of claim 1, further comprising a recycle line configured to recycle at least a portion of effluent from the center compartment to one or both of an inlet of the anodic compartment and an inlet of the cathodic compartment.

18. The apparatus of claim 1, further comprising a gas recovery system configured to remove one or more of hydrogen, carbon dioxide, or oxygen from one or more of the effluent the anodic compartment, the cathodic compartment, or the center compartment.

19. The apparatus of claim 18, wherein the gas recovery system includes one or more vacuum strippers.

20. The apparatus of claim 1, wherein the anode includes an oxygen evolving coating including one of iridium suboxides, Magneli phase titanium dioxide, stainless steel, iridium-cobalt (Ir—Co), iridium-tantalum (Ir—Ta), or other iridium or tantalum species.

21. A method of generating hydrogen, carbon dioxide, and oxygen from seawater, the method comprising:
introducing the seawater into each of an anodic compartment, a cathodic compartment, and a center compartment of an electrolytic cell including:
an anode;
a cathode;
a first cation permeable fluidic separator spaced from the anode and defining the anodic compartment;
a second cation permeable fluidic separator spaced from the cathode and defining the cathodic compartment;
a center compartment defined between the first cation permeable fluidic separator and the second cation permeable fluidic separator; and
a flow control system configured to independently control flow of the seawater through each of the anodic compartment, the cathodic compartment, and the center compartment;
maintaining one or both of a flow rate through the center compartment or a current across the anode and the cathode at levels that result in effluent from the center compartment exhibiting a pH within a predetermined range; and
maintaining a flow rate through the cathodic compartment at level that mitigates formation of scale on the cathode;
maintaining a flow rate through the anodic compartment at a level that mitigates blinding of the anode; and
removing one or more of hydrogen, carbon dioxide, or oxygen from effluent from one or more of the anodic compartment, the center compartment, or the cathodic compartment, respectively.

22. The method of claim 21, further comprising maintaining the flow rate through the cathodic compartment at a lowest level that mitigates formation of scale on the cathode.

23. The method of claim 21, further comprising maintaining the flow rate through the anodic compartment at a lowest level that mitigates blinding of the anode.

24. The method of claim 21, further comprising introducing a portion of effluent from the anodic compartment into an inlet of the anodic compartment with the seawater introduced into the anodic compartment.

25. The method of claim 21, further comprising introducing a portion of effluent from the anodic compartment into an inlet of the cathodic compartment with the seawater introduced into the anodic compartment.

26. The method of claim 21, further comprising introducing a portion of effluent from the anodic compartment into an inlet of the anodic compartment with the seawater introduced into the anodic compartment.

27. The method of claim 21, further comprising introducing a portion of the effluent from the center compartment into an inlet of the center compartment with the seawater introduced into the center compartment.

28. The method of claim 21, further comprising maintaining the flow rate through at least one of the anodic compartment, the cathodic compartment, or the center compartment at a different level that at least one other of the anodic compartment, the cathodic compartment, or the center compartment.

29. The method of claim 28, further comprising maintain the flow rate through the cathodic compartment at a higher flow rate than the flow rate through the center compartment.
